(19) United States
(12) Patent Application Publication
(10) Pub. No.: US 2026/0014544 A1
(43) Pub. Date: Jan. 15, 2026

(54) RECYCLING OF AMINE FUNCTIONALIZED METAL-ORGANIC FRAMEWORK SORBENTS

(71) Applicant: Mosaic Materials, Inc., Alameda, CA (US)

(72) Inventors: Michael Alexander Boreen, San Francisco, CA (US); Aeri Gosselin, El Cerrito, CA (US); Ignacio Luz, Alameda, CA (US); Graham Wenz, Richmond, CA (US)

(21) Appl. No.: 18/768,679

(22) Filed: Jul. 10, 2024

(51) Int. Cl. B01J 20/22; B01J 20/28; B01J 20/30; B01J 20/34; B29C 48/00

(52) U.S. Cl. CPC B01J 20/223; B01J 20/28004; B01J 20/3021; B01J 20/3475; B29C 48/022; B01J 2220/4875

(57) ABSTRACT

A method of recycling a degraded solid sorbent includes: washing the degraded solid sorbent containing a metal-organic framework material, an amine grafted to the metal-organic framework material and a binder, with a non-solvent to remove the amine from the degraded sorbent, thereby obtaining a washed sorbent comprising the metal-organic framework material and the binder; converting the washed sorbent to a remodified sorbent containing a second metal-organic framework material, and a second amine grafted to the second metal-organic framework material; and forming a recycled solid sorbent from the remodified sorbent by extrusion. Alternatively, the regenerated sorbent is formed by treating the degraded solid sorbent with an acid or base to break down the metal-organic framework material, thereby recovering an organic linker; reacting the recovered organic linker with a metal salt to form a second metal-organic framework material; and grafting a second amine to the second metal-organic framework material.

### BACKGROUND

This disclosure is directed to a method of recycling metal-organic framework (MOF) sorbents, in particular a method of recycling degraded sorbents containing an amine functionalized MOF material and a binder.

Carbon dioxide (CO₂) separation technology is a cyclic process. After a sorbent is saturated with CO₂, a desorption step is performed to regenerate the sorbent and to release the captured CO₂ for storage or further use.

MOF sorbents are widely used in cyclic processes for carbon capture. While MOF sorbents manufactured from new raw materials can last thousands of cycles, they eventually degrade to a point where their performance is no longer cost effective, and they need to be replaced.

Without a method to recycle the degraded MOF sorbents, new MOF materials must then be manufactured from completely new raw materials. In addition, without an effective recycling method, the degraded MOF sorbents must be disposed of, leading to additional costs associated with safe disposal of materials.

Manufacturing MOF is generally expensive, and the raw materials, especially the organic linker compounds and post-synthetic modifying ligands, usually contribute a high percentage of the overall manufacturing cost. When a MOF sorbent is used for application in carbon capture, this manufacturing and replacement cost represents a large portion of the overall cost to capture a given quantity of carbon dioxide. Accordingly, there is a continuing need for methods that are effective to recycle degraded MOF sorbents.

### SUMMARY

A method of recycling a degraded solid sorbent includes: washing the degraded solid sorbent comprising a metal-organic framework material, an amine grafted to the metal-organic framework material and a binder, with a non-solvent to remove the amine from the degraded sorbent, thereby obtaining a washed sorbent comprising the metal-organic framework material and the binder; converting the washed sorbent to a remodified sorbent comprising a second metal-organic framework material, and a second amine grafted to the second metal-organic framework material; and forming a recycled solid sorbent from the remodified sorbent by extrusion.

Another method of recycling a degraded solid sorbent includes: treating the degraded solid sorbent which comprises a metal-organic framework material, an amine grafted to the metal-organic framework material, and a binder, with an acid or base to break down the metal-organic framework material, thereby recovering an organic linker from the metal-organic framework material; reacting the recovered organic linker with a metal salt to form a second metal-organic framework material; grafting a second amine to the second metal-organic framework material to form a regenerated sorbent; combining the regenerated sorbent with a second binder to form a formulated composition; and extruding the formulated composition, thereby forming the recycled solid sorbent.

Yet another method of recycling a degraded solid sorbent includes: mixing a degraded solid sorbent comprising a metal-organic framework material, an amine grafted to the metal-organic framework material and a binder, with a non-solvent and a second amine to form a slurry; and drying the slurry, thereby forming a recycled solid sorbent

### BRIEF DESCRIPTION OF THE DRAWINGS

A description of the figures, which are meant to be exemplary and not limiting, is provided in which:

FIG. 1 illustrates methods of recycling degraded solid sorbents;

FIG. 2 is a graph of N₂ adsorbed per washed solid sorbent of Example 1 (mmol/g) versus pressure (bar) and demonstrates that the washed solid sorbent of Example 1 is of high quality and mostly devoid of grafted amines; and

FIG. 3 is a graph of CO₂ adsorbed per amine (mol/mol) versus temperature (° C.) and compares the performance of pristine solid sorbent with the recycled sorbents.

### DETAILED DESCRIPTION

A detailed description of one or more embodiments is presented herein by way of exemplification and not limitation.

The inventors hereof have found methods of recycling degraded MOF sorbents. In particular, degraded MOFs can be recycled to recover raw materials or intermediate products that can be used in the manufacture of new MOF sorbents. The effective recycling methods as described herein enable the degraded MOF sorbents to be converted to pristine MOF sorbents using a fraction of the quantity of new raw materials that would be necessary without recycling. This can lead to large savings in manufacturing costs and a dramatic reduction in the CO₂ capture cost.

As used herein, a degraded sorbent refers to a sorbent that has been used in applications such as cyclic CO₂ capture, and degraded over time, causing a loss in effectiveness/performance. A degraded solid sorbent comprises a MOF material, an amine grafted to the MOF material, and a binder. “Grafted” means that the amine is coordinated to an open metal site of the MOF material.

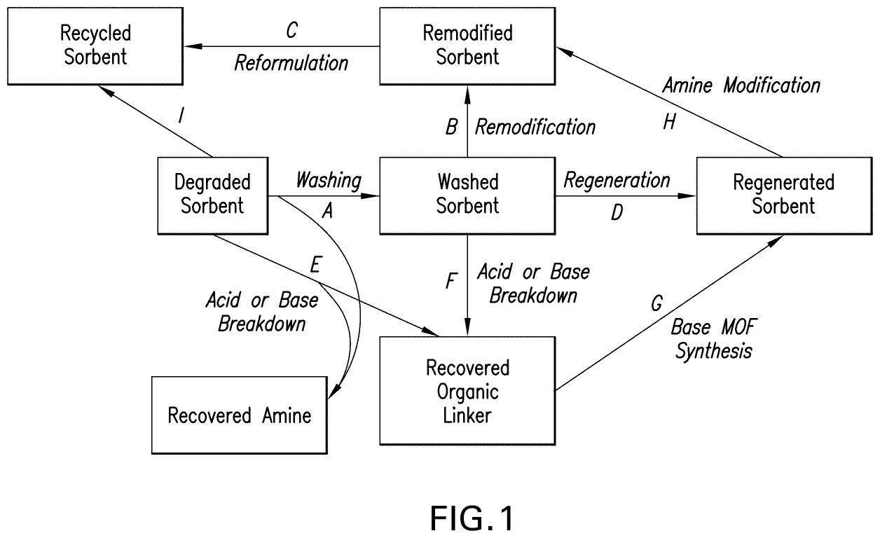

FIG. 1 illustrates methods of recycling a degraded solid sorbent. In process (A), the degraded solid sorbent is washed with a non-solvent to remove the amine from the degraded sorbent, thereby obtaining a washed sorbent. The washing can remove greater than about 85 wt %, greater than about 90 wt %, or greater than 95 wt % of the amine grafted to the MOF material. Advantageously, the washing does not remove the binder in the degraded solid sorbent. The washed sorbent comprises the metal-organic framework material and the binder. Accordingly, no additional binder or less binder may be needed to prepare the final recycled sorbent from the washed sorbent.

The degraded solid sorbent can be in a particulate form, for example, the degraded solid sorbent can be pellets. Preferably the particle size of the degraded solid sorbent is reduced before it is washed with the non-solvent. The degraded solid sorbent can be milled or ground to particles with a largest dimension of less than 600 microns, for example about 0.5 micron to about 600 microns, or about 1 micron to about 600 microns. Reducing the size of the degraded solid sorbent to a size within the ranges as described herein before washing can greatly improve the efficiency of these washings (i.e., requires less solvent and time to remove a given amount of the amine).

The amount of the non-solvent used can vary depending on the specific degraded solid sorbent being washed. For example, the non-solvent used can be about 10 milliliters to about 200 milliliters per gram of the degraded solid sorbent.

The degraded solid sorbent can be stirred in the non-solvent at a temperature of about 16° C. to about 40° C. or at room temperature for about 5 minutes to about 48 hours or about 1 hour to about 24 hours. After stirring, the obtained mixture can be filtered to afford the washed sorbent. The washed sorbent is further washed with a non-solvent to remove the residual amines on the filtered sorbent. The filtrate can include the amine, degraded amine, and the non-solvent. The amine in the filtrate can be recovered for further use by separating the non-solvent and the degraded amine by fractional distillation.

Advantageously, the washing process (A) does not damage the MOF material. Accordingly, if the MOF material in the degraded sorbent is not damaged, the washed sorbent can be directly converted to a remodified sorbent in process (B) as shown in FIG. 1. The process comprises contacting the washed sorbent with a second amine. The second amine can comprise the amine recovered from the degraded solid sorbent, a fresh amine, or both. The fresh amine can be compositionally the same or different from the amine recovered from the degraded solid sorbent.

For example, the remodified sorbent can be synthesized by mixing the washed sorbent with the second amine optionally in the presence of a non-solvent (e.g. water and/or methanol) to form a slurry, and drying the slurry to form the remodified sorbent. The drying step can be conducted at an elevated temperature (e.g. from 20° C. to about 120° C., from about 25° C. to about 100° C., or from 60 to about 80° C.). The drying time can vary, and can be the time needed to provide a remodified sorbent having a moisture content of less than 12 wt % based on the total weight of the remodified sorbent. The remodified sorbent can comprise the MOF material in the washed sorbent as the second MOF material, and a second amine grafted to the second MOF material. The remodified sorbent can also include the binder from the degraded solid sorbent.

The remodified sorbent can be converted to a recycled sorbent via process (C). For example, the remodified sorbent can be combined with a second binder to form a formulated composition. The second binder can be compositionally the same or different from the binder in the degraded solid sorbent. Alternatively, since the binder from the degraded solid sorbent can remain in a sufficient amount in the remodified sorbent, the remodified sorbent (e.g. prepared via processes A and B or prepared via processes A, D, and H) can be converted to the recycled sorbent without adding any additional binder.

Additives such as lubricants or plasticizers can be added if needed. The formulated composition can be extruded to form the recycled sorbent. The extrusion may be performed at elevated pressure (ranging from atmospheric pressure to several hundred bar), at elevated temperatures (ranging from room temperature to 300° C.) or in a protective atmosphere (noble gases, nitrogen or mixtures thereof). Any combinations of these conditions are possible as well.

The recycled solid sorbent can be in the form of pellets. The pellets can have a particle size of about 0.1 millimeter (mm) to about 10 mm, preferably about 0.3 mm to about 3 mm, more preferably about 0.7 mm to about 1.5 mm. The recycled solid sorbent can also be present in the form of a standalone film or a coating on another substrate or a self-standing monoliths. The film or coating can have a thickness of about 0.01 mm to about 10 mm, preferably about 0.1 mm to about 1.0 mm.

If the MOF material in the degraded sorbent is damaged, the MOF material can be regenerated via a hydrothermal process (D) after washing. During the process, the washed sorbent can be treated under hydrothermal conditions to form a regenerated sorbent, which comprises a second metal-organic framework material having the repaired framework. Hydrothermal conditions can include heating the washed sorbent in a non-solvent at a temperature of about 80° C. to about 120° C. or under reflux for about 10 minutes to about 5 hours. The heated mixture can be optionally cooled, then filtered to obtain the regenerated sorbent. The obtained regenerated sorbent can be washed with an additional non-solvent. The regenerated sorbent can then be converted to the remodified sorbent via process (H). The conditions of the process (H) can be the same as discussed herein in the context of process (B). The remodified sorbent can be converted to the recycled sorbent with process (C) as described herein.

If the MOF material in the washed sorbent cannot be repaired via a hydrothermal process (D), the MOF material can be broken down in an acid or base via process (F) to recover the organic linker in the MOF material, and the recovered organic linker can be used as a raw material to make a new MOF material via process (G). Alternatively, the degraded sorbent with a damaged MOF material can be treated with an acid or base to break down the MOF material without first washing the degraded MOF material with a non-solvent to remove the amine grafted to the MOF via process (E). Milling the degraded solid sorbent before the acid or base treatment can improve the efficiency of the process.

During an acid treatment, the degraded sorbent or the washed sorbent can be treated with an acid such as hydrochloric acid or acetic acid to break down the MOF material, generating an organic linker. The regenerated organic linker can be collected by filtration. To break down the MOF material, the degraded or washed sorbent can be stirred in an acid at a temperature of about 18° C. to about 40° C. or about 20° C. or about 40° C. or at room temperature for about half an hour to about 24 hours. The reaction mixture can then be filtered, and the solid collected on the filter plate can be washed with a non-solvent (e.g. water) until the pH of the filtrate is greater than or equal to 6, and/or the conductivity is equal to or less than 0.05 mS/cm. The washed solid can be dried at room temperature or an elevated temperature to recover the organic linker. For process E where the degraded sorbent is treated with an acid, the filtrate includes the amine that grafted to the MOF material in the degraded sorbent. The amine can be fractionally distilled from the filtrate, optionally after neutralization of the acid in the filtrate. The recovered amine as be used in processes B, H, and I if needed.

The degraded solid sorbent or the washed solid sorbent can also react with a base such as sodium hydroxide or potassium hydroxide to break down the MOF material in the degraded or washed sorbent, generating a salt of the organic linker. To break down the MOF material, the degraded or washed sorbent can be stirred in the base at a temperature of about 18° C. to about 40° C. or about 20° C. or about 40° C. or at room temperature for about half an hour to about 24 hours. The reaction mixture can be filtered to remove solids. Optionally, the reaction mixture is first partially neutralized to a pH of about 11 to about 12 to obtain a partially neutralized product, then the partially neutralized product is filtered to remove solids. Partial neutralization allows for a less hazardously basic mixture to be filtered.

The filtrate can be acidified to a pH of 2 or less, preferably 1 or less to obtain an acidified product. If the pH of the filtrate is greater than 2, the yield of the recovered organic linker can be undesirable. The organic linker can be collected as a precipitate via filtration from the acidified product, and then washed with a non-solvent such as water until the filtrate is no longer acidic. The washed solid can be dried at room temperature or at an elevated temperature to recover the organic linker. For process E where the degraded sorbent is treated with a base, the filtrate includes the amine that grafted to the MOF material in the degraded sorbent. After neutralization, the amine can be fractionally distilled from the filtrate. The recovered amine as be used in processes B, H, and I if needed.

The organic linker generated from the base breakdown of the degraded sorbent or the washed sorbent does not have to be isolated as a solid. The filtered basic solution of the reaction mixture (whether partially neutralized or not) can be adjusted to a pH of about 9 to about 10. The solution with the adjusted pH contains the organic ligand in a deprotonated form, and can be used directly via process (G) to form a regenerated sorbent without isolating the organic linker.

The recovered organic linker can react with a metal salt in the presence of a reaction solvent to form a regenerated sorbent via process (G). Any method known in the art for the synthesis of a MOF material can be used. The metal salt can be a salt of at least one of Mg, Ca, Ba, Al, Sc, Zr, V, Cr, Mn, Fe, Co, Ni, Cu, Zn, Ti, Cd, or Eu. The salt can be an acetate, a hydroxide, a carbonate, a nitrate, a chloride, a sulfate, or a combination thereof. The reaction can be conducted at a temperature of about 50° C. to about 120° C., or about 60° C. to about 100° C., or under reflex for a period of about 10 minutes to about 24 hours depending on the specific reactants used. A base may be present during the reaction. The regenerated sorbent can be obtained via filtration, and washed to remove unreacted starting materials or byproducts if any. The regenerated product can then be converted to the recycled sorbent via processes H and C as discussed herein.

As shown in FIG. 1, the degraded solid sorbent can also be recycled via process (I) by combining the degraded solid sorbent and an amine, and optionally a non-solvent to make a slurry, then drying the slurry under reduced pressure to obtain the recycled sorbent.

As used herein, the MOF material in the degraded sorbent, washed sorbent, regenerated sorbent, remodified sorbent, or the recycled sorbent includes inorganic nodes connected by organic linkers. The inorganic nodes comprise metal sites, which can be ions of least one of Mg, Ca, Ba, Al, Sc, Zr, V, Cr, Mn, Fe, Co, Ni, Cu, Zn, Ti, Cd, or Eu, preferably the ions of at least one of Mg, Mn, Zn, or Ni. The organic linkers can comprise at least one of a carboxylate, a triazolate, or an imidazolate, preferably a carboxylate. Examples of the organic linkers include, but are not limited to, 4,4′-dihydroxy-(1,1′-biphenyl)-3,3′-dicarboxylate, 2,5-dihydroxybenzene-1,4-dicarboxylate, 4,6-dihydroxybenzene-1,3-dicarboxylate, benzene-1,4-dicarboxylate, benzene-1,3,5-tricarboxylate, 3,3′,4,4′-benzophenone-tetracarboxylate, benzene-1,2,4,5-tetracarboxylate, trans-1,4-cyclohexanedicarboxylate, 1H,7H-[1,4]dioxino [2,3-F: 5,6-F′]bisbenzotriazolate, 1,5-dihydrobenzo[1,2-d:4,5-d′]bis ([1,2,3]triazolate, 3,5-dimethyl-1H-pyrazole-4-carboxylate, 5-(pyridin-3-yl)benzene-1,3-dicarboxylate, 1,3,5-tri(1H-tetrazol-5-yl) benzene, 2-methylimidazolate, 2-ethylimidazolate, and 1-benzyl-1H-imidazolate. Other suitable known organic linkers can also be used. Preferably the organic linkers comprise 4,4′-dihydroxy-(1,1′-biphenyl)-3,3′-dicarboxylate. These organic linkers can be recovered via an acid or base process (E) or (F) as described herein.

Examples of the MOFs can include, but are not limited to, MOF-74, MOF-274,HKUST-1, MI1-100, MIL-101, MOF-525, MOF-2, MOF-505, and UiO-66. Additional MOFs include but are not limited to those described in Chem. Soc. Rev. 2020, 49, 2751-2798. A preferred MOF is Mg₂(dobpdc) where the inorganic nodes comprise Mg ions and the organic linkers comprise 4,4′-dihydroxy-(1, 1′-biphenyl)-3,3′-dicarboxylate (dobpdc).

The amine and the second amine can independently be a monoamine; a diamine such as a primary/primary diamine, a primary/secondary diamine, a primary/tertiary diamine, and a secondary/secondary diamine; a polyamine such as a triamine, a tetramine, and an aminopolymer; or a bifunctional amine.

The monoamines can be monoalkylamines, dialkylamines, trialkylamines, monoarylamines, diarylamines, triarylamines, and mixed alkyl-aryl-amines. Examples of the monoamines include, but are not limited to, aniline, n-butylamine, n-pentylamine, n-hexylamine, diphenylamine, and triethylamine.

Examples of the diamines include, but are not limited to, ethylene diamine, 2,2-dimethyl-1,3-propanediamine, 1,3-diaminopentane, 2-methylpropane-1,2-diamine, N-ethylethylenediamine, N-isopropylethylenediamine, N-butylethylenediamine, N-pentylethylenediamine, N-hexylethylenediamine, N,N-dimethylethane-1,2-diamine, N,N-diethylethylenediamine, N,N-diisopropylethylene diamine, N,N-dimethylpropylenediamine, N,N′-dimethylethane-1,2-diamine, 2-(aminomethyl)piperidine, and N,N-diethyl-N-methylethylenediamine.

Suitable polyamines include, but are not limited to, bis(3-aminopropyl)amine, N,N′-bis(3-aminopropyl)-1,4-butanediamine, tetraethylene pentaamine, polyethyleneimine, and polypropyleneimine. Preferably, the amine includes a primary/secondary diamine disclosed herein.

As used herein, a bifunctional amine refers to an amine having an additional functional group other than an amino group. Examples of the bifunctional amines include, but are not limited to, amino-alcohols (also known as alkanolamines).

The amine can be recovered from process A or E. The recovered amine can be used in processes B, H, and I if needed.

The binder and the second binder can each independently comprise at least one of a cellulose polymer, starch, a siloxane polymer, a cellulose-siloxane polymer, polyvinyl pyrrolidone, polyvinyl alcohol, poly (ethyl vinyl acetate), polyacrylate, polymethacrylate, polyvinylpyrrolidone, polyisobutene, or a polyurethane, alumina, silica, zirconia, titania, alkoxysilanes, clays, an oxide of magnesium and of beryllium, or a biopolymer.

The cellulose polymer can comprise at least one of methyl cellulose, amino methyl cellulose, hydroxyl methyl cellulose, hydroxyethyl methylcellulose, ethylhydroxy ethylcellulose, hydroxy propyl cellulose, hydroxyl propyl methylcellulose, carboxymethylcellulose, other cellulosic polymers, starches, or other natural gums. The siloxane polymer can comprise poly (hydroxymethyl) siloxane. Examples of the cellulose-siloxane polymer include cellulose methyl siloxane, cellulose amino methyl siloxane, or a combination thereof. Examples of the clay include silica-alumina clays, montmorillonites, kaolins, bentonites, halloysites, dickites, nacrites, anauxites, and attapulgite

A content of the binder in the recycled solid sorbent and the degraded sorbent can be about 0.5 to about 20 wt %, about 1 to about 15 wt % or about 2 to about 10 wt %, based on a total weight of the recycled solid sorbent or the degraded sorbent.

The optional lubricant in the recycled sorbent can include at least one of magnesium stearate, polyethylene glycol, graphite, glycerol, or propylene glycol. If present, a content of the lubricant in the recycled solid sorbent can be about 0.5 to about 5 wt %, or about 1 to about 5 wt %, based on a total weight of the recycled solid sorbent.

The optional plasticizer in the recycled sorbent can include at least one of methyl cellulose, polyethylene glycol, sugars, or starch. If present, a content of the lubricant in the recycled solid sorbent can be about 0.5 to about 5 wt %, or about 1 to about 5 wt %, based on a total weight of the recycled solid sorbent.

As used herein, the non-solvent, if used in process A-I, can comprise at least water, or an alcohol. Examples of the alcohol include methanol, ethanol, and isopropanol. A combination of water and an alcohol, or a combination of different alcohols can be used.

Unless disclosed otherwise, the reactions disclosed herein are conducted at atmospheric pressure.

The recycling of degraded MOF sorbents are further illustrated by the following non-limiting examples.

### EXAMPLES

### Example 1

About 250 mL total of water was used to wash 9 g of powdered MOF sorbent; 100 mL was used to suspend the material for the initial filtration, then 3 washes with 50 ml of water were performed. This process removed about 94% of the amine from the MOF sorbent, as determined using 1H NMR spectroscopy on the digested sorbent before and after the washing.

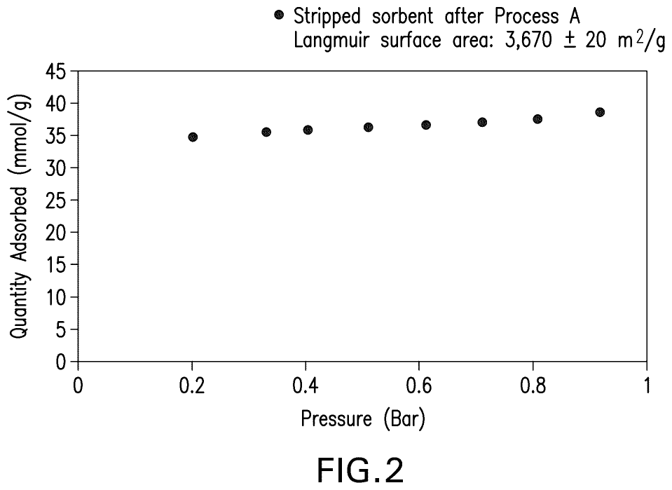

Surface area measurements show that the MOF in the washed sorbent is high quality/has not been damaged by the washing process (see FIG. 2). Notably, this stripping process does not remove the binder from the material (confirmed using NMR spectroscopy).

### Example 2

Experiments demonstrate excellent recovery of material performance (carbon dioxide capacity) when Processes A and B are performed using heavily degraded sorbent. About 3equivalents of amine was added to the wet, washed sorbent (product of Process A, Example 1). The amine and the MOF were mixed into a uniform slurry within a glass vessel, and then the resulting slurry was dried in a vacuum drier at 80° C. until the moisture content of the product was less about 12% to obtain a reaminated product.

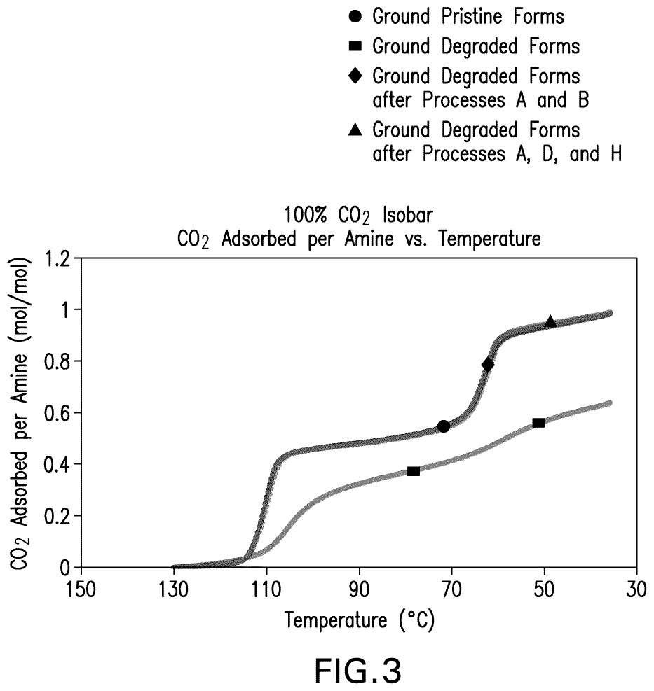

As shown in the 100% CO2 TGA isobar data in FIG. 3, the carbon dioxide capacity of the degraded sorbent was much lower than that of pristine sorbent. When the heavily degraded sorbent was washed with water (Process A) to remove the amine and then reaminated (Process B), the resulting material displayed remarkably similar capacity to that of the pristine sorbent.

### Example 3

The example shows that running a regeneration process consisting of treating water-stripped base MOF to the hydrothermal conditions used to prepare base MOF from new raw materials does not lead to observable framework damage (surface area before regeneration is about the same as the surface area after regeneration). About 2.4 g of washed MOF from Example 1 (mass determined here on a dry basis) and 60 mL of water were added to a round bottom flask. The mixture was heated to reflux for 1 h, then filtered to collect the regenerated product. (Process D) Amination of this material (Process H) yielded aminated MOF with a CO2 capacity effectively identical to that of both pristine sorbent and degraded sorbent recycled through Processes A and B as shown in FIG. 3.

### Example 4

A reactor was charged with milled degraded sorbent containing Mg2(dobpdc), an amine grafted to Mg2(dobpdc), and a binder. Acetic acid in water was added, and the mixture was stirred at room temperature overnight. Water was added, and the diluted reaction mixture was filtered. The solid collected on the filter plate was washed with water until the pH of the filtrate was greater than or equal to 6 and conductivity was equal to or less than 0.05 mS/cm. Product 4,4′-Dihydroxybiphenyl-3,3′-dicarboxylic acid (dobpdc) was collected and dried in vacuum oven at an elevated temperature, such as 40° C.

The recovered dobpdc was milled, and the milled dobpdc was mixed with 4 eq of NaOH at room temperature in water. The mixture was stirred for 15 min, then 2.25 eq of Mg(OAc)2 in water was added, and the resulting mixture was heated to reflux with stirring for 1 h, then filtered and washed (with water) to obtain the regenerated sorbent.

### Example 5

A reactor was charged with aqueous sodium hydroxide and milled degraded solid sorbent containing Mg2(dobpdc), an amine grafted to the Mg2(dobpdc), and a binder. The reaction mixture was stirred overnight at room temperature, and then partially neutralized to pH between about 11 to about 12. The reaction mixture was filtered. Crude H2Na2dobpdc solution was added to a reactor, acidified to pH of about 1, then filtered to afford product dobpdc, which was dried in vacuum oven at an elevated temperature, such as 40° C.

The recovered dobpdc was used as a raw material to prepare a MOF sorbent following the procedures described in Example 4.

Set forth below are various embodiments of the disclosure.

Embodiment 1. A method of recycling a degraded solid sorbent comprising: washing the degraded solid sorbent comprising a metal-organic framework material, an amine grafted to the metal-organic framework material and a binder, with a non-solvent to remove the amine from the degraded sorbent, thereby obtaining a washed sorbent comprising the metal-organic framework material and the binder; converting the washed sorbent to a remodified sorbent comprising a second metal-organic framework material, a second amine grafted to the second metal-organic framework material, and the binder; and forming a recycled solid sorbent from the remodified sorbent by extrusion.

Embodiment 2. The method as in any prior embodiment, further comprising reducing a particle size of the degraded solid sorbent before the degraded solid sorbent is washed with the non-solvent.

Embodiment 3. The method as in any prior embodiment, further comprising milling the degraded solid sorbent to particles having a largest dimension of about 0.5 to about 600 microns before the degraded solid sorbent is washed with the non-solvent.

Embodiment 4. The method as in any prior embodiment, wherein washing the degraded solid sorbent comprises stirring the degraded solid sorbent in the non-solvent to obtain a mixture; and filtering the mixture to obtain the washed sorbent.

Embodiment 5. The method as in any prior embodiment, wherein converting the washed sorbent to the remodified sorbent comprises contacting the washed sorbent with the second amine, and the remodified sorbent comprises the metal-organic framework material from the degraded solid sorbent as the second metal-organic framework material.

Embodiment 6. The method as in any prior embodiment, wherein forming the recycled solid sorbent comprises combining the remodified sorbent with a second binder to form a formulated composition; and extruding the formulated composition to obtain the recycled solid sorbent.

Embodiment 7. The method as in any of Embodiments 1 to 5, wherein forming the recycled solid sorbent comprises extruding the remodified sorbent without adding any additional binder.

Embodiment 8. The method as in any prior embodiment, further comprising hydrothermally treating the washed sorbent to form a second metal-organic framework material; and grafting the second amine to the second metal-organic framework material, thereby forming the remodified sorbent.

Embodiment 9. The method as in any of Embodiments 1 to 7, further comprising treating the washed sorbent with an acid or base to break down the metal-organic framework material, thereby recovering an organic linker from the metal-organic framework material.

Embodiment 10. The method as in Embodiment 9, further comprising reacting the recovered organic linker with a metal salt to form the second metal-organic framework material, grafting the second amine to the second metal-organic framework material, thereby forming the remodified sorbent.

Embodiment 11. The method as in any of prior embodiment, wherein the non-solvent comprises at least one of water or an alcohol.

Embodiment 12. A method of recycling a degraded solid sorbent comprising: treating the degraded solid sorbent which comprises a metal-organic framework material, an amine grafted to the metal-organic framework material, and a binder, with an acid or base to break down the metal-organic framework material, thereby recovering an organic linker from the metal-organic framework material; reacting the recovered organic linker with a metal salt to form a second metal-organic framework material; grafting a second amine to the second metal-organic framework material to form a remodified sorbent; combining the remodified sorbent with a second binder to form a formulated composition; and extruding the formulated composition, thereby forming the recycled solid sorbent.

Embodiment 13. The method as in Embodiment 12, further comprising milling the degraded solid sorbent to particles having a largest dimension of about 0.5 to about 600 microns before the degraded solid sorbent is treated with the acid or base.

Embodiment 14. The method as in Embodiment 12 or 13, wherein the degraded solid sorbent is treated with an acid, and the acid is HCl or acetic acid.

Embodiment 15. The method as in Embodiment 12 or 13, wherein the degraded solid sorbent is treated with a base, and the base is sodium hydroxide or potassium hydroxide.

Embodiment 16. The method as in Embodiment 15, wherein the degraded solid sorbent is treated with a base to form a base treated product, and the method further comprises neutralizing the base treated product to a pH of about 11 to about 12 to obtain a partially neutralized product; removing a solid from the partially neutralized product; acidifying a filtrate to a pH of about 2 or less to obtain an acidified product; and collecting the recovered organic linker as a precipitate from the acidified product.

Embodiment 17. A method of recycling a degraded solid sorbent, the method comprising: mixing a degraded solid sorbent comprising a metal-organic framework material, an amine grafted to the metal-organic framework material and a binder, with a non-solvent and a second amine to form a slurry; and drying the slurry, thereby forming a recycled solid sorbent.

Embodiment 18. The method as in any prior embodiment, wherein the amine and the second amine each independently comprises at least one of a monoamine, a diamine, a polyamine, or a bifunctional amine.

Embodiment 19. The method as in any prior embodiment, wherein the binder comprises at least one of a cellulose polymer, starch, a siloxane polymer, a cellulose-siloxane polymer, polyvinyl pyrrolidone, polyvinyl alcohol, poly (ethyl vinyl acetate), polyacrylate, polymethacrylate, polyvinylpyrrolidone, polyisobutene, or a polyurethane, alumina, silica, zirconia, titania, alkoxysilanes, clays, an oxide of magnesium and of beryllium, or a biopolymer.

The compositions, methods, and process can alternatively comprise, consist of, or consist essentially of, any appropriate materials, or steps herein disclosed. The compositions, methods, and processes can additionally, or alternatively, be formulated/carried out so as to be devoid, or substantially free, of any materials (or species), or steps, which are otherwise not necessary to the achievement of the function or objectives of the compositions, methods, and processes.

All ranges disclosed herein are inclusive of the endpoints, and the endpoints are independently combinable with each other (e.g., a range of “5 wt % to 20 wt %” is inclusive of the endpoints and all intermediate values of the ranges of “5 wt % to 25 wt %,” etc.). “Combinations” is inclusive of blends, mixtures, alloys, reaction products, and the like. The terms “first,” “second,” and the like, do not denote any order, quantity, or importance, but rather are used to distinguish one element from another. The use of the terms “a” and “an” and “the” and similar referents in the context of describing the invention (especially in the context of the following claims) are to be construed to cover both the singular and the plural, unless otherwise indicated herein or clearly contradicted by context. “Or” means “and/or” unless clearly stated otherwise. The term “about” is intended to include the degree of error associated with measurement of the particular quantity based upon the equipment available at the time of filing the application. For example, “about” can include a range of ±8% or 5%, or 2% of a given value.

Unless defined otherwise, technical and scientific terms used herein have the same meaning as is commonly understood by one of skill in the art to which this invention belongs.

All references cited herein are incorporated by reference in their entirety. While typical embodiments have been set forth for the purpose of illustration, the foregoing descriptions should not be deemed to be a limitation on the scope herein. Accordingly, various modifications, adaptations, and alternatives can occur to one skilled in the art without departing from the spirit and scope herein.

1. A method of recycling a degraded solid sorbent, the method comprising:
washing the degraded solid sorbent comprising a metal-organic framework material, an amine grafted to the metal-organic framework material and a binder, with a non-solvent to remove the amine from the degraded sorbent, thereby obtaining a washed sorbent comprising the metal-organic framework material and the binder;
converting the washed sorbent to a remodified sorbent comprising a second metal-organic framework material, a second amine grafted to the second metal-organic framework material, and the binder; and
forming a recycled solid sorbent from the remodified sorbent by extrusion.

2. The method of claim 1, further comprising reducing a particle size of the degraded solid sorbent before the degraded solid sorbent is washed with the non-solvent.

3. The method of claim 1, further comprising milling the degraded solid sorbent to particles having a largest dimension of about 0.5 to about 600 microns before the degraded solid sorbent is washed with the non-solvent.

4. The method of claim 1, wherein the non-solvent comprises at least one of water or an alcohol.

5. The method of claim 1, wherein washing the degraded solid sorbent comprises stirring the degraded solid sorbent in the non-solvent to obtain a mixture; and filtering the mixture to obtain the washed sorbent.

6. The method of claim 1, wherein converting the washed sorbent to the remodified sorbent comprises contacting the washed sorbent with the second amine, and the remodified sorbent comprises the metal-organic framework material from the degraded solid sorbent as the second metal-organic framework material.

7. The method of claim 1, wherein forming the recycled solid sorbent comprises combining the remodified sorbent with a second binder to form a formulated composition; and extruding the formulated composition to obtain the recycled solid sorbent.

8. The method of claim 1, wherein forming the recycled solid sorbent comprises extruding the remodified sorbent without adding any additional binder.

9. The method of claim 1, further comprising hydrothermally treating the washed sorbent to form a second metal-organic framework material; and grafting the second amine to the second metal-organic framework material, thereby forming the remodified sorbent.

10. The method of claim 1, further comprising treating the washed sorbent with an acid or base to break down the metal-organic framework material, thereby recovering an organic linker from the metal-organic framework material.

11. The method of claim 10, further comprising reacting the recovered organic linker with a metal salt to form the second metal-organic framework material, grafting the second amine to the second metal-organic framework material, thereby forming the remodified sorbent.

12. The method of claim 1, wherein the amine and the second amine each independently comprises at least one of a monoamine, a diamine, a polyamine, or a bifunctional amine.

13. The method of claim 1, wherein the binder comprises at least one of a cellulose polymer, starch, a siloxane polymer, a cellulose-siloxane polymer, polyvinyl pyrrolidone, polyvinyl alcohol, poly (ethyl vinyl acetate), polyacrylate, polymethacrylate, polyvinylpyrrolidone, polyisobutene, or a polyurethane, alumina, silica, zirconia, titania, alkoxysilanes, clays, an oxide of magnesium and of beryllium, or a biopolymer.

14. A method of recycling a degraded solid sorbent, the method comprising:
treating the degraded solid sorbent which comprises a metal-organic framework material, an amine grafted to the metal-organic framework material, and a binder, with an acid or base to break down the metal-organic framework material, thereby recovering an organic linker from the metal-organic framework material;
reacting the recovered organic linker with a metal salt to form a second metal-organic framework material;
grafting a second amine to the second metal-organic framework material to form a remodified sorbent;
combining the remodified sorbent with a second binder to form a formulated composition; and
extruding the formulated composition, thereby forming the recycled solid sorbent.

15. The method of claim 14, further comprising milling the degraded solid sorbent to particles having a largest dimension of about 0.5 to about 600 microns before the degraded solid sorbent is treated with the acid or base.

16. The method of claim 14, wherein the degraded solid sorbent is treated with an acid, and the acid is HCl or acetic acid.

17. The method of claim 14, wherein the degraded solid sorbent is treated with a base, and the base is sodium hydroxide or potassium hydroxide.

18. The method claim 14, wherein the degraded solid sorbent is treated with a base to form a base treated product, and the method further comprises neutralizing the base treated product to a pH of about 11 to about 12 to obtain a partially neutralized product; removing a solid from the partially neutralized product; acidifying a filtrate to a pH of about 2 or less to obtain an acidified product; and collecting the recovered organic linker as a precipitate from the acidified product.

19. The method of claim 15, wherein the amine and the second amine each independently comprises at least one of a monoamine, a diamine, a polyamine, or a bifunctional amine.

20. A method of recycling a degraded solid sorbent, the method comprising:
mixing a degraded solid sorbent comprising a metal-organic framework material, an amine grafted to the metal-organic framework material and a binder, with a non-solvent and a second amine to form a slurry; and
drying the slurry, thereby forming a recycled solid sorbent.
